(19) United States
(12) Patent Application Publication
(10) Pub. No.: US 2002/0069804 A1
(43) Pub. Date: Jun. 13, 2002

(54) Method and apparatus for an automatic horizontal movement of a movable object utilizing the gravitation force

(76) Inventor: Pichit Likitcheva, Bangkok (TH)

Correspondence Address: LADAS & PARRY, 26 WEST 61ST STREET, NEW YORK, NY, 10023, US

(21) Appl. No.: 09/910,693

(22) Filed: Jul. 20, 2001

Related U.S. Application Data
(63) Continuation-in-part of application No. 09/733,762, filed on Dec. 8, 2000.

(51) Int. Cl. H02P 9/04

(52) U.S. Cl. 114/61.1

(57) ABSTRACT

When the load of a movable object is applied on to a platform of the invention it will create a counter force to the original point of application by means of specifically arranged mechanical devices. With such action the platform turns into an inclined surface to provide an automatic moving force for the movable object without requiring any outside power source except for the force of gravity.

### BACKGROUND OF THE INVENTION

Of all the forces in nature gravitation force is the least understood, and therefore the least utilized, by mankind, even though the influence of gravity is immensely immeasurable. Throughout the history of mankind the only application being utilized has been only in its one-directional aspect that could not be directly reversed or otherwise altered.

However, with an inventive arrangement of some mechanical devices already known to man, the limitation on the benefit of the gravitation force could somehow be broaden in its scope of application. For instance, as disclosed in the U.S. Pat. No. 6,019,055 by the present inventor, the load (gravitation force) on a floating platform could be diverted to various parts of the platform in order to create a more balanced force distribution by means of hydraulic and spring actions of the mechanical devices that were installed under the floating platform. Wherein under a normal circumstance this will only create a concentrated load on the platform and there will be no benefit derived from it whatsoever.

### SUMMARY OF THE INVENTION

It is therefore an objective of the present invention to provide a method and apparatus that will utilize the gravitation force to create a horizontal movement of a movable object.

The invention can be realized by redirecting the resultant of the one-directional (and therefore one point of application) vertical force nature of the gravity to various other purposefully-designated locations in order to create a counter force on the original point of application, by using mechanical devices that were specifically arranged to create such action.

Under an arrangement in accordance with this invention, when a mass of object is being set or applied on a hydraulically-operated platform of the invention the weight of the mass will start a chain reaction on the mechanical devices specifically-arranged under the platform; and this will create a lift or a counter force on the platform at the location that was being originaly loaded. This action will turn the normally horizontal surface of the platform into an inclined plane. Therefore, if the mass of object is furnished with a set of wheels for mobility, it will be able to move freely down the sloping surface of the platform on its own accord and without the need for external force or any outside intervention.

In accordance with another arrangement of the present invention a movable mass on a platform is connected to a rotating unbalanced wheel situated directly below it. And, due to the gravitation force, the heavier portion of the wheel will have the tendency of falling to the lowest possible point of the rotation, and with the assistance of the specially arranged mechanical devices, will turn the platform into an inclined plain.

An apparatus of the invention will be able to create an automatic and continuously mobile vehicle to provide an unending source of power for various applications, such as a power generator and the likes, if a series of this apparatus were arranged in a closed loop fashion.

### BRIEF DESCRIPTION OF THE DRAWINGS

FIG. 1 is a schematic view showing an apparatus in accordance with the present invention in its normal state.

FIG. 2 is a schematic view showing an apparatus in accordance with the present invention shown in FIG. 1 under a load bearing condition.

FIG. 3 is a schematic side view showing another embodiment of an apparatus in accordance with the present invention.

FIG. 4 is a rear view of an apparatus shown in FIG. 3.

FIG. 5 is a schematic view showing an arrangement for a series of the apparatus in FIG. 3 for an automatic and continuous movement in accordance with the present invention.

### DETAILED DESCRIPTION OF THE PREFERRED EMBODIMENTS

Referring to the drawings, the illustrative embodiments of an apparatus for the automatic horizontal movement of a movable object utilizing gravitation force and the method of operation in accordance with the present invention will be explained in detail.

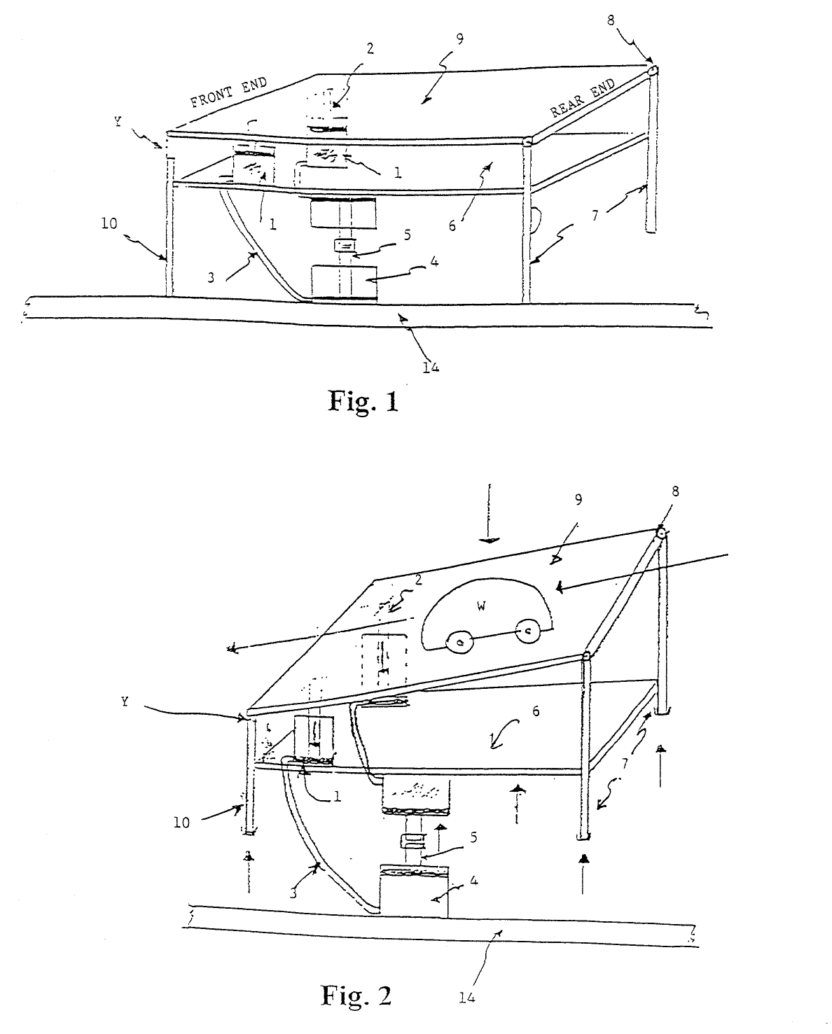

FIG. 1 shows an apparatus in accordance with the present invention in a normal and resting state, and comprising a flat surface platform 9 having a front end and a rear end. The rear end of platform 9 is attached by hinge 8 or any similar connector to rear legs 7, whereas the front end of platform 9 is overhanging above front legs 10 with a predetermined clearance Y. The degree of clearance Y will dictate the degree of inclination of platform 9 during the operation state. Both legs 7 and 10 stand on floor 14 and are movable in a vertical direction as shown by the arrows. Plate 6 is located below platform 9 and positively connected to legs 7, 10 in order to be movable in a vertical direction together.

Plate 6 is being supported by major, high capacity, hydraulic cylinder 4 and piston 5 resting on floor 14 as shown in the drawing. On top of plate 6 and under platform 9 near to the front end are a number of minor, low capacity, cylinders 1 and pistons 2 which are being hydraulically linked to major cylinder 4 and piston 5 by hydraulic line 3.

During an operation state as shown in FIG. 2, when a load W is applied on the surface of platform 9, platform 9 will force minor piston 2 to act on the major cylinder and piston 4, 5 by way of hydraulic line 3. With such action between the lower capacity minor cylinders and pistons 1, 2 and the higher capacity major cylinder and piston 4, 5, plate 6 and legs 7, 10 positively connected to it will be simultaneously raised to a predetermined level.

While the plate 6 and its legs 7, 10 are being forced to move to a higher level by the hydraulic action of major cylinder and piston, platform 9 will also be raised up by the same degree. However, since the minor cylinders and pistons 1, 2 attached to the underside of platform 9 are in a compressed state, the front end of platform 9 will be lowered until pistons 2 reach its stroke limit or as limited by the top end of front legs 10 (when the value of clearance Y reach zero). However, the rear end of platform 9 will retain its new height and begins to incline toward the front end from its rear hinged end, creating a sloping surface for an automatic movement of the wheeled object W toward the lower end of platform 9. And when platform 9 is no longer being subjected to the load W, all of the cylinders and pistons, both major and minor, will return to their original state as shown in FIG. 1.

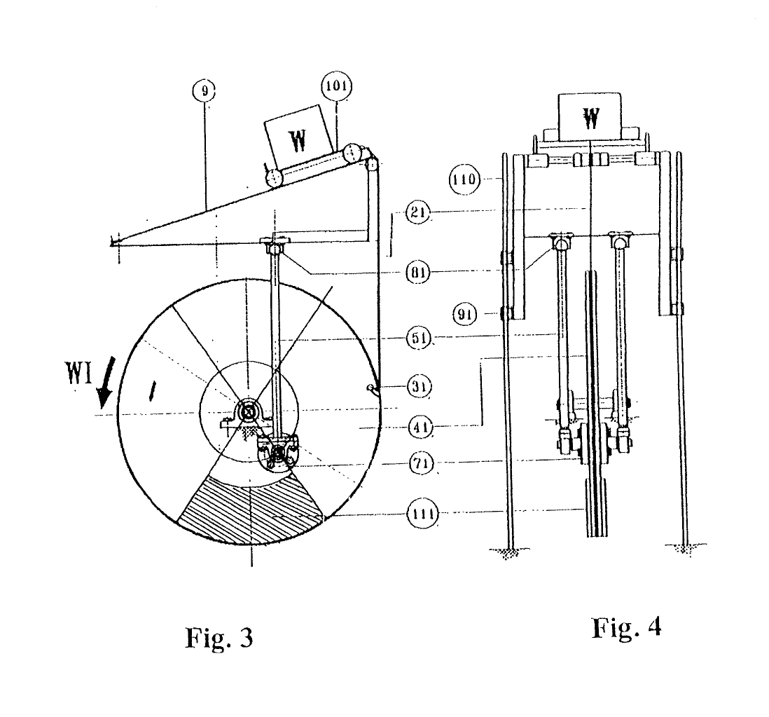

FIG. 3 and FIG. 4 show another embodiment of the apparatus in accordance with the present invention, wherein mass W is set on slider 101 to be movable on platform 9. Situated directly below platform 9 is a large diameter unbalanced wheel 41. Wheel 41 is being connected to its perimeter at location 31 to the rear end of slider 101 by a suitable length of sling 21. Wheel 41 is rotate in the direction shown by arrow WI, and consisting of a heavier section 111 and an eccentrically-located hub 71. Hub 71 has its associate arm 51 connected to the underside of platform 9 at location 81. Platform 9 is being stabilized to be movable in the vertical direction by rod and ring 110, 91 at all four of its corners.

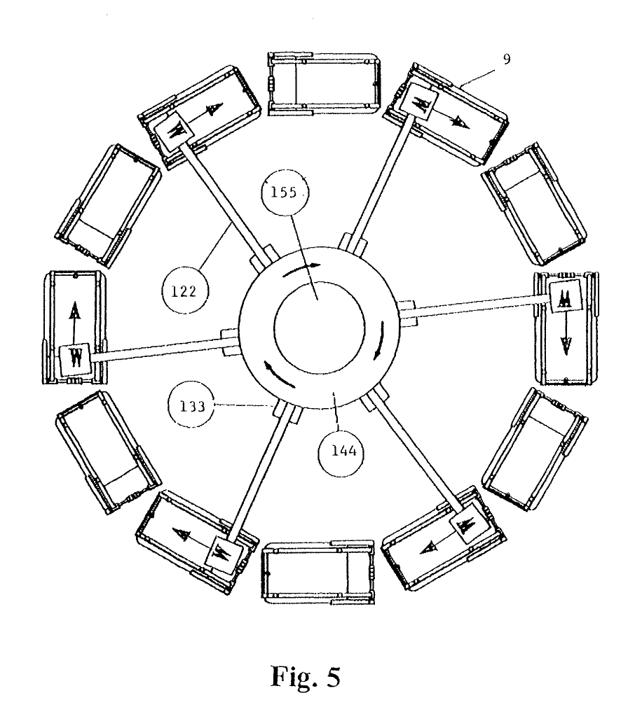

When mass W on slider 101 is being set on platform 9 it will slide down the sloping surface of platform 9, and in consequence, will rotate the large wheel 41 in the direction of arrow WI by means of sling 21 attached to its perimeter at position 31. With the rotation of wheel 41, hub 71 will push platform 9 to a higher elevation by means of arm 51 as shown in FIG. 3 and FIG. 4. Therefore creating a sloping surface for the movement of slider 101 onto the next set of apparatus arranged in a closed loop fashion shown in FIG. 5. When arm 51 has reached its full stroke and slider 101 has completed its sliding limit on platform 9 the weight of the heavier section 111 of wheel 41, together with the weight of platform 9, will pull the now empty slider 101 back to the original position on the platform and be ready to take on a new mass W.

As shown in FIG. 5 a series of mass W are sliding in the direction as shown by the arrows on a series of platforms 9 in a closed loop fashion. Each unit of mass W is being connected to revolving plate 144 around shaft 155 by means of connecting arms 122 and connectors 133.

It is to be noted that even though the embodiments of the present invention as illustrated and explained herewith contained the essence of the invention in its correct and concise state, it is still within the scope of the invention to make some adjustment and/or variation to them. For instance, the number of major cylinder and piston could be more than one units, and this also is applicable to the number of minor cylinders and pistons, as long as the total capacity of all the minor units is lower than that of the major unit.

1. A method for the utilization of a gravitation force in providing an inclined surface for an automatic movement of a movable object in a horizontal direction, including the diversion of a force to the pre-designated location(s) by means of hydraulic action of first hydraulic device and second hydraulic device installed under the platform, said method comprising:
in response to the gravitation force bearing on the platform, the first hydraulic device cause the upward movement of the second hydraulic device, and the upward movement of second hydraulic device, in turn, cause the rise in elevation of the platform creating an inclined surface.

2. A method as claimed in claim 1 wherein the first hydraulic device has a precedence over and dictating the operation of the second hydraulic device.

3. An apparatus for the utilization of gravitation force in providing an inclined surface for an automatic movement of a movable object in a horizontal direction, comprising a top platform with one end being connected to rear legs by a hinge, first hydraulic device of lesser capacity on the lower plate and said lower plate is positively connected to front and rear legs underneath said top platform at opposite end, and second hydraulic device of greater capacity on the floor and being hydraulically linked to said first hydraulic device on said lower plate.

4. An apparatus as claimed in claim 3 wherein the total capacity of first hydraulic device is less than the total capacity of second hydraulic device.

5. A method for the utilization of a gravitation force in providing an inclined surface for an automatic movement of a movable object in a horizontal direction, including the diversion of a force to the pre-designated location by means of a rotation wheel with an unbalanced weight distribution to create a counter action on the said surface.

6. An apparatus for the utilization of a gravitation force in providing an inclined surface for an automatic movement of a movable object in a horizontal direction, comprising a slider on a platform, the rear end of said slider is connected to the perimeter of an unbalanced wheel below, and said unbalanced wheel consists of specially arranged mechanical devices to create said inclined surface without the use of additional power source.
